(19) United States
(12) Patent Application Publication
(10) Pub. No.: US 2026/0087094 A1
(43) Pub. Date: Mar. 26, 2026

(54) METHOD AND DEVICE FOR GENERATING A VECTOR REPRESENTATION OF TIME-SERIES SENSOR DATA STREAMS

(71) Applicant: Robert Bosch GmbH, Stuttgart (DE)

(72) Inventors: Nian Hua, Magstadt (DE); Ivan Batalov, Pittsburgh, PA (US); Sascha Wirges, Buehl (DE)

(21) Appl. No.: 19/317,210

(22) Filed: Sep. 3, 2025

(30) Foreign Application Priority Data
Sep. 20, 2024 (DE) 10 2024 209 063.8

(51) Int. Cl. G06F 17/16

(52) U.S. Cl. CPC G06F 17/16

(57) ABSTRACT

A computer-implemented method for generating a vector representation of time-series sensor data streams. The method includes: applying a first machine learning algorithm to the plurality of channels of the at least one time-series sensor data stream to generate a vector representation of the time-series sensor data streams that includes the position embedding for each of the plurality of time portions; assigning at least one channel- and sensor-specific embedding to the plurality of channels of the time-series sensor data streams; and applying a second machine learning algorithm to the plurality of channels of the time-series sensor data streams to generate a vector representation of a combined embedding of the at least one channel- and sensor-specific embedding of the plurality of channels of the time-series sensor data streams. A corresponding device for generating a vector representation of time-series sensor data streams is also described.

### CROSS REFERENCE

The present application claims the benefit under 35 U.S.C. § 119 of Germany Patent Application No. DE 102024 209 063.8 filed on September 20, 2024, which is expressly incorporated herein by reference in its entirety.

### FIELD

The present invention relates to a computer-implemented method for generating a vector representation of time-series sensor data streams. The present invention further relates to a method for preprocessing time-series sensor data streams for a method for generating a vector representation of time-series sensor data streams. The present invention further relates to a device for generating a vector representation of time-series sensor data streams.

### BACKGROUND INFORMATION

Recent progress in the field of multimodal AI foundation models is promising. One such model is "ImageBind: One Embedding Space To Bind Them All,” Girdhar et al., for example, which combines five data modalities into a single embedding space and enables new capabilities such as creating images from an audio clip.

Another multimodal AI foundation model is "Meta-Transformer: A Unified Framework for Multimodal Learning,” Zhang et al., which proposes various model architectures for modularized multimodal foundation models.

Sensor modalities such as motion sensors (often referred to as inertial measurement units or IMUs), audio and heart rate sensors, etc. are also among the additional modalities that can be included in such multimodal foundation models. In general, incorporating additional modalities requires specific types of encoders to encode the data of said specific modality, as described in "ImageBind: One Embedding Space To Bind Them All,” Girdhar et al., where the architecture may or may not be modality-specific.

Coding the IMU sensor modality has traditionally been challenging, mainly for several reasons:

1) There can be different types of sensors, such as an accelerometer, a gyroscope, a magnetometer, etc. 2) The sensors can be installed in different locations. IMU sensors can be attached to various parts of the body such as the head, hands, arms, legs, back, etc. If the sensors are attached to physical objects, such as a motor vehicle, the sensors can also be located for example at the front, rear or side of the motor vehicle. 3) Sensor signals can have different frequencies. For example, acceleration sensors can generate signals at different frequencies than magnetometers.

An object of the present invention is therefore to provide a sensor encoder that can process sensor inputs having such variability and generate consistent representations.

The object may be achieved by a method having certain features of the present invention and a method having certain features of the present invention. The object is also achieved by a device having certain features of the present invention.

### SUMMARY

According to a first aspect of the present invention, a computer-implemented method for generating a vector representation of time-series sensor data streams is provided. According to an example embodiment of the present invention, the method includes the following steps:

providing at least one time-series sensor data stream having a plurality of channels; dividing the at least one time-series sensor data stream into the plurality of channels; and dividing the time-series sensor data stream of each channel into a plurality of time portions; assigning at least one position embedding to each of the plurality of time portions; applying a first machine learning algorithm to the plurality of channels of the at least one time-series sensor data stream to generate a vector representation of the at least one time-series sensor data stream that comprises the position embedding for each of the plurality of time portions;

assigning at least one channel- and sensor-specific embedding to the plurality of channels of the at least one time-series sensor data stream; and applying a second machine learning algorithm to the plurality of channels of the at least one time-series sensor data stream to generate a vector representation of a combined embedding of the at least one channel- and sensor-specific embedding of the plurality of channels of the at least one time-series sensor data stream.

It is understood that the steps according to the present invention, as well as other optional steps, do not necessarily have to be executed in the order shown, but can also be executed in a different order. Other intermediate steps can also be provided. The individual steps can also comprise one or more sub-steps without departing from the scope of the method according to the present invention.

In order to handle the variability of the sensor data, such as differences in dimensions, sampling rates, etc., the method according to the present invention is used to generate a vector representation of time-series sensor data streams and is used as a sensor encoder in a sensor foundation model.

This transformer-based model processes sensor data by splitting it into 1D signals that overlap in time. This process is referred to as patchification. Position embeddings are assigned to each of these 1D patches or time portions and input into a common transformer.

All data is preprocessed before encoding. The data sets are standardized into a canonical format in which each sample is characterized by a consistent sampling rate and temporal overlap between samples. Activity classification is a practical application of the sensor foundation model. The model uses data from wearable apparatuses to perform activity classification.

According to a second aspect of the present invention, a method for preprocessing time-series sensor data streams for the method according to the present invention for generating a vector representation of time-series sensor data streams according to the first aspect is provided. According to an example embodiment of the present invention, the method includes the following steps:

providing a plurality of time-series sensor data streams, wherein a particular sensor providing a time-series sensor data stream has a different frequency; and resampling the plurality of time-series sensor data streams, in particular by interpolation, to a uniform frequency, or dividing the plurality of time-series sensor data streams into time portions such that the plurality of time-series sensor data streams have a uniform frequency.

According to a third aspect of the present invention, a device for generating a vector representation of time-series sensor data streams is provided. According to an example embodiment of the present invention, the device includes:

at least one sensor configured to provide at least one time-series sensor data stream having a plurality of channels; means for dividing the at least one time-series sensor data stream into the plurality of channels and means for dividing the time-series sensor data stream of each channel into a plurality of time portions; means for assigning at least one position embedding to each of the plurality of time portions; means for applying a first machine learning algorithm to the plurality of channels of the at least one time-series sensor data stream to generate a vector representation of the time-series sensor data streams that comprises the position embedding for each of the plurality of time portions; means for assigning at least one channel- and sensor-specific embedding to the plurality of channels of the time-series sensor data streams; and means for applying a second machine learning algorithm to the plurality of channels of the time-series sensor data streams to generate a vector representation of a combined embedding of the at least one channel- and sensor-specific embedding of the plurality of channels of the time-series sensor data streams.

The explanations given for the method of the present invention apply accordingly to the device of the present invention. It is understood that linguistic modifications of features formulated for the method of the present invention can be reformulated for the device of the present invention in accordance with standard linguistic practice, without such formulations having to be explicitly listed here.

Compared to the related art, the method and the device of the present invention provide the following advantages. In particular, the present method is able to overcome the challenges arising from the coding of time-series data of varying channel number and channel frequency.

In a further aspect of the present invention, it is provided that the at least one position embedding indicates a position in a sequence of the plurality of time portions for each of the plurality of time portions. This advantageously enables an improved representation of the input data.

In a further aspect of the present invention, it is provided that the at least one channel- and sensor-specific embedding for the plurality of channels of the time-series sensor data streams comprises a channel designation, a position on an object or a person of a sensor providing the time-series sensor data stream and/or a sensor type. This further allows for an improved representation of the input data.

In a further aspect of the present invention, it is provided that the time-series sensor data stream is provided by an inertial measuring unit, wherein each channel comprises a univariate time-series sensor data stream, in particular an acceleration in an x-, y- or z-direction or an angular velocity, and wherein the time-series sensor data streams of the plurality of channels overlap in time. The univariate sensor data can thus each be processed separately by the subsequent machine learning algorithm.

In a further aspect of the present invention, it is provided that the first machine learning algorithm and the second machine learning algorithm are each formed by a transformer-encoder model. This proves to be particularly advantageous for encoding sensor data.

In a further aspect of the present invention, a computer program having program code is provided for executing at least parts of the method of the present invention in one of its aspects when the computer program is executed on a computer. In other words, a computer program comprising instructions that, when the program is executed by a computer, cause the computer to execute the method of the present invention/steps of the method of the present invention in one of its aspects.

In a further aspect of the present invention, a computer-readable data carrier having program code of a computer program is provided for executing at least parts of the method of the present invention in one of its aspects when the computer program is executed on a computer. In other words, the present invention relates to a computer-readable medium comprising instructions that, when executed by a computer, cause the computer to execute the method of the present invention/steps of the method of the present invention in one of its aspects.

The described embodiments and developments of the present invention can be combined with one another as desired.

Further possible embodiments, developments and implementations of the present invention also include combinations not explicitly mentioned of features of the present invention described above or in the following relating to the exemplary embodiments of the present invention.

### BRIEF DESCRIPTION OF THE DRAWINGS

The figures are intended to impart further understanding of the example embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a schematic flow chart of an exemplary embodiment of the present method for generating a vector representation of time-series sensor data streams.

FIG. 2 is a schematic flow chart of an exemplary embodiment of the present method for preprocessing time-series sensor data streams for a method for generating a vector representation of time-series sensor data streams.

FIG. 3 is a schematic block diagram of an exemplary embodiment of a present device for generating a vector representation of time-series sensor data streams.

### DETAILED DESCRIPTION OF EXAMPLE EMBODIMENTS

In the figures, identical reference signs denote identical or functionally identical elements, parts or components, unless stated otherwise.

The present method is also explained with reference to the other figures.

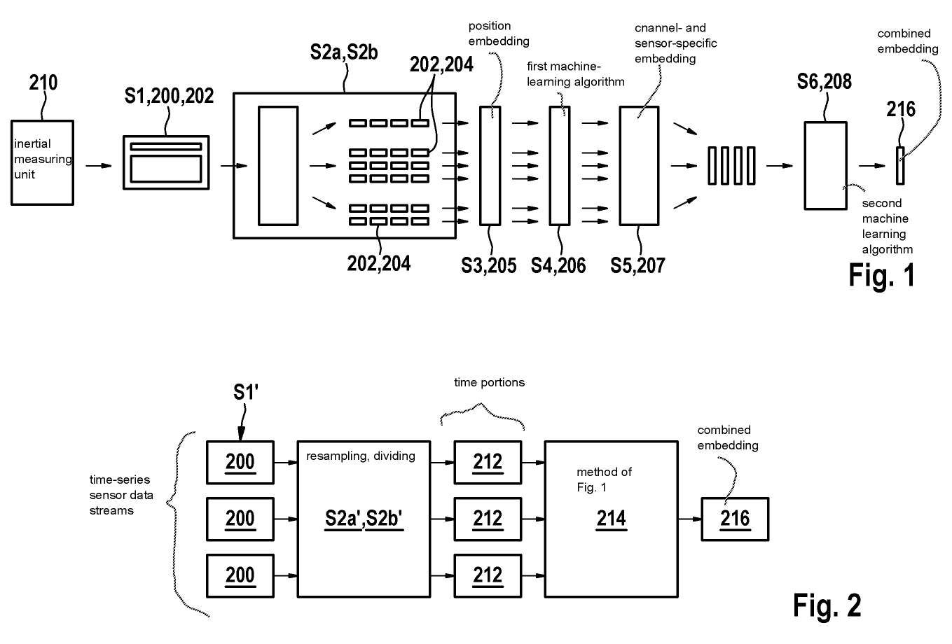

FIG. 1 is a schematic flow chart of an exemplary embodiment of the present method for generating a vector representation of time-series sensor data streams.

The method comprises providing S1 at least one time-series sensor data stream 200 having a plurality of channels 202, dividing S2a the at least one time-series sensor data stream 200 into the plurality of channels 202 and dividing S2b the time-series sensor data stream 200 of each channel 202 into a plurality of time portions 204 and assigning S3 at least one position embedding 205 to each of the plurality of time portions 204.

Furthermore, the method comprises: applying S4 a first machine learning algorithm 206 to the plurality of channels 202 of the at least one time-series sensor data stream 200 to generate a vector representation of the time-series sensor data streams that comprises the position embedding 205 for each of the plurality of time portions 204, assigning S5 at least one channel- and sensor-specific embedding 207 to the plurality of channels 202 of the time-series sensor data streams, and applying S6 a second machine learning algorithm 208 to the plurality of channels 202 of the time-series sensor data streams to generate a vector representation of a combined embedding 216 of the at least one channel- and sensor-specific embedding 207 of the plurality of channels 202 of the time-series sensor data streams.

The at least one position embedding 205 indicates a position in a sequence of the plurality of time portions 204 for each of the plurality of time portions 204.

The at least one channel- and sensor-specific embedding 207 for the plurality of channels 202 of the time-series sensor data streams comprises a channel designation, a position on an object or a person of a sensor providing the time-series sensor data stream 200 and/or a sensor type.

The at least one time-series sensor data stream 200 is provided by an inertial measuring unit 210, wherein each channel comprises a univariate time-series sensor data stream 200, in particular an acceleration in an x-, y- or z-direction or an angular velocity, and wherein the time-series sensor data streams of the plurality of channels 202 overlap in time.

The first machine learning algorithm 206 and the second machine learning algorithm 208 are each formed by a transformer-encoder model.

FIG. 2 is a schematic flow chart of an exemplary embodiment of the present method for preprocessing time-series sensor data streams for a method for generating a vector representation of time-series sensor data streams.

The method comprises providing S1‘ a plurality of time-series sensor data streams, wherein a particular sensor providing a time-series sensor data stream 200 has a different frequency, and resampling S2a‘ the plurality of time-series sensor data streams, in particular by interpolation, to a uniform frequency, or dividing S2b‘ the plurality of time-series sensor data streams into time portions such that the plurality of time-series sensor data streams have a uniform frequency.

Dividing S2b‘ the plurality of time-series sensor data streams into time portions is carried out by using a defined time window and by embedding each time portion such that the same dimensionality is generated, in particular by using a layer of a convolutional neural network followed by a global pooling layer in the temporal dimension.

Reference sign 212 denotes the respectively divided time portions. Reference sign 214 denotes the method described in FIG. 1 and reference sign 216 denotes the output of the method according to FIG. 1, i.e., the vector representation of the time-series sensor data streams.

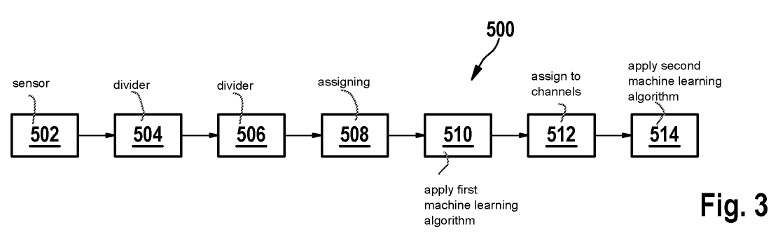

FIG. 3 is a schematic block diagram of an exemplary embodiment of a present device 500 for generating a vector representation of time-series sensor data streams. The device comprises at least one sensor 502 configured to provide at least one time-series sensor data stream 200 having a plurality of channels 202.

Furthermore, the device comprises means 504 for dividing S2a the at least one time-series sensor data stream 200 into the plurality of channels 202, means 506 for dividing S2b the time-series sensor data stream 200 of each channel 202 into a plurality of time portions 204, means 508 for assigning S3 at least one position embedding 205 to each of the plurality of time portions 204, and means 510 for applying S4 a first machine learning algorithm 206 to the plurality of channels 202 of the at least one time-series sensor data stream 200 to generate a vector representation of the time-series sensor data streams that comprises the position embedding 205 for each of the plurality of time portions 204.

Furthermore, the device comprises means 512 for assigning S5 at least one channel- and sensor-specific embedding 207 to the plurality of channels 202 of the time-series sensor data streams, and means 514 for applying a second machine learning algorithm 208 to the plurality of channels 202 of the time-series sensor data streams to generate a vector representation 216 of a combined embedding of the at least one channel- and sensor-specific embedding 207 of the plurality of channels 202 of the time-series sensor data streams.

What is claimed is:

1. A computer-implemented method for generating a vector representation of time-series sensor data streams, comprising the following steps:
providing at least one time-series sensor data stream having a plurality of channels;
dividing the at least one time-series sensor data stream into the plurality of channels, and dividing the time-series sensor data stream of each channel into a plurality of time portions;
assigning at least one position embedding to each of the plurality of time portions;
applying a first machine learning algorithm to the plurality of channels of the at least one time-series sensor data stream to generate a vector representation of the at least one time-series sensor data stream that includes the position embedding for each of the plurality of time portions;
assigning at least one channel- and sensor-specific embedding to the plurality of channels of the at least one time-series sensor data stream; and
applying a second machine learning algorithm to the plurality of channels of the at least one time-series sensor data stream to generate a vector representation of a combined embedding of the at least one channel- and sensor-specific embedding of the plurality of channels of the at least one time-series sensor data stream.

2. The computer-implemented method according to claim 1, wherein the at least one position embedding indicates a position in a sequence of the plurality of time portions for each of the plurality of time portions.

3. The computer-implemented method according to claim 1, wherein the at least one channel- and sensor-specific embedding for the plurality of channels of the at least one time-series sensor data stream includes: (i) a channel designation, or (ii) a position on an object, or (iii) a person of a sensor providing the at least one time-series sensor data stream and/or a sensor type.

4. The computer-implemented method according to claim 1, wherein the at least one time-series sensor data stream is provided by an inertial measuring unit), wherein each of the channels includes a univariate time-series sensor data stream including an acceleration in an x-, y- or z-direction or an angular velocity, and wherein the time-series sensor data streams of the plurality of channels overlap in time.

5. The computer-implemented method according to claim 1, wherein the first machine learning algorithm and the second machine learning algorithm are each formed by a transformer-encoder model.

6. A computer-implemended method for preprocessing time-series sensor data streams for a method for generating a vector representation of time-series sensor data streams, comprising the following steps:
providing a plurality of time-series sensor data streams, wherein each sensor providing a time-series sensor data stream has a different frequency; and
(i) resampling the plurality of time-series sensor data streams, by interpolation, to a uniform frequency, or (ii) dividing the plurality of time-series sensor data streams into time portions such that the plurality of time-series sensor data streams have a uniform frequency.

7. The computer-implemented method according to claim 6, wherein the dividing of the plurality of time-series sensor data streams into time portions is carried out by using a defined time window and by embedding each time portion such that the same dimensionality is generated, by using a layer of a convolutional neural network followed by a global pooling layer in a temporal dimension.

8. A non-transitory computer-readable data carrier on which is stored program code of a computer program for generating a vector representation of time-series sensor data streams, the program code, when executed by a computer, causing the computer to perform the following steps:
providing at least one time-series sensor data stream having a plurality of channels;
dividing the at least one time-series sensor data stream into the plurality of channels, and dividing the time-series sensor data stream of each channel into a plurality of time portions;
assigning at least one position embedding to each of the plurality of time portions;
applying a first machine learning algorithm to the plurality of channels of the at least one time-series sensor data stream to generate a vector representation of the at least one time-series sensor data stream that includes the position embedding for each of the plurality of time portions;
assigning at least one channel- and sensor-specific embedding to the plurality of channels of the at least one time-series sensor data stream; and
applying a second machine learning algorithm to the plurality of channels of the at least one time-series sensor data stream to generate a vector representation of a combined embedding of the at least one channel- and sensor-specific embedding of the plurality of channels of the at least one time-series sensor data stream.

9. A device for generating a vector representation of time-series sensor data streams, the device comprising:
at least one sensor configured to provide at least one time-series sensor data stream having a plurality of channels;
an element configured to divide the at least one time-series sensor data stream into the plurality of channels and an element configured to divide the at least one time-series sensor data stream of each channel into a plurality of time portions;
an element configured to assign at least one position embedding to each of the plurality of time portions;
an arrangement configured to apply a first machine learning algorithm to the plurality of channels of the at least one time-series sensor data stream to generate a vector representation of the time-series sensor data streams that includes the position embedding for each of the plurality of time portions;
an element configured to assign at least one channel- and sensor-specific embedding to the plurality of channels of the time-series sensor data streams; and
an element configured to apply a second machine learning algorithm to the plurality of channels of the time-series sensor data streams to generate a vector representation of a combined embedding of the at least one channel- and sensor-specific embedding of the plurality of channels of the time-series sensor data streams.
